(19) United States
(12) Patent Application Publication
(10) Pub. No.: US 2004/0182120 A1
(43) Pub. Date: Sep. 23, 2004

(54) Locker Lock

(75) Inventors: Edward Flory, Crown Point, IN (US); Christopher Haczynaski, Crown Point, IN (US)

Correspondence Address: CALFEE HALTER & GRISWOLD, LLP, 800 SUPERIOR AVENUE, SUITE 1400, CLEVELAND, OH, 44114, US

(73) Assignee: MASTER LOCK COMPANY, Oak Creek, WI (US)

(21) Appl. No.: 10/605,693

(22) Filed: Oct. 17, 2003

Related U.S. Application Data
(60) Provisional application No. 60/419,250, filed on Oct. 17, 2002.

(51) Int. Cl. E05B 65/06

(52) U.S. Cl. 70/134

(57) ABSTRACT

A locker lock that provides for increased security and ease of use. The locker lock can be a vertical built-in lock or a horizontal built-in lock. In each case the lock is symmetrical such that it can be used in either right-handed or left-handed lockers. The locker lock provides for increased security by increasing the distance the lock bolt must travel. The locker lock also provides for an easy combination changing mechanism, such that the combination can be changed without opening the lock and the locker lock can accommodate a large number of lock combinations.

### CROSS REFERENCE TO RELATED APPLICATIONS

This invention claims priority to U.S. Provisional Patent Application Serial No. 60/419,250, entitled LOCKER LOCK DIAL filed Oct. 17, 2002.

### BACKGROUND OF INVENTION

Lockers have been around for many years as a means of preventing the unauthorized access of others to articles contained within the locker. Over the years, locks have been made in many different shapes and sizes, and with their respective right-hand and left-hand door models, for many applications. The locker designs have changed slightly, but the locker locking mechanism has stayed fairly constant.

Typically, locker locking mechanisms consist of two types:

the single-point latching mechanism and the multiple-point latching system. Both types of locker locking mechanisms are positioned furthest from the hinges and nearest the edge of the locker door that opens, and in the center position of that edge. This increases the strength of the locking mechanism by providing the best possible mechanical advantage. The single-point latching system provides a single point where the locker door is prohibited from opening. This type of latching system typically is de-signed to utilize either a hang-on lock or a horizontal built-in lock. The multiple-point latching mechanism provides multiple points where the locker door is prohibited from opening. The multiple-point latching system typically is designed to utilize either a hang-on lock or a vertical built-in lock.

Historically there have been three types of built-in locker locks: the vertical built-in lock; the horizontal built-in spring bolt; and the horizontal built-in dead bolt. Each of these locks have been designed to accommodate both the right-hand and the left-hand door models, doubling the total number of built-in locks used for locker to six.

The vertical built-in lock is named for the relative movement of its locking bolt and assembly to the locker. Present vertical built-in locks are available for both doors through the use of multiple models. Present vertical built-in locks provide for a certain amount of movement of the locking bolt. The amount of movement in which the locking bolt can move can lead to manipulation of the lock by flexing the locker, thereby allowing the locker rods to be removed from their respective locking positions, and compromising the locker lock integrity.

Both the horizontal built-in spring bolt and the horizontal built-in dead bolt are named for their relative locking bolt movements, and their particular modes of locking. Both of the horizontal build-in locks have a designed degree of movement allotted to the locking bolt. This amount of movement can lead to manipulation of locker lock by flexing the locker. This is especially true on larger lockers. As with the vertical built-in locks, flexing of the locker can allow for movement of the locking bolt, thereby allowing for the locker door to be opened.

Present horizontal built-in dead bolt designs provide for increased security, as compared with the present horizontal built-in spring bolt designs; however the increased security compromises the ease of use when locking and unlocking the locker. The horizontal dead-bolt design prohibits manipulation of the locking bolt by contact with objects that can fit through holes in the locker. To open the locker without a key, the combination must be dialed. Once the dial reaches the last combination, the lock is ready to open. Further turning of the dial pushes the locking bolt into the retracted or unlocked position, thereby allowing the locker door to open. The locking bolt is then left in the open position until the dial is turned back the opposite direction. The locker door must then be closed and the dial must be turned to extend the bolt to the locked position. This makes the locking dead bolt inconvenient to use, as the door and dial must simultaneously be manipulated in order to shut the locker.

Present horizontal built-in spring bolt designs provide for increased convenience over the horizontal built-in dead bolt, in that once the combination is dialed and the dial is turned further to push the locking bolt into the unlocked position, the locker door can be opened and closed with-out additional manipulation of the dial. This is because the bolt is spring-loaded. However, since the locking bolt is spring-loaded, it can be manipulated by pushing on the bolt with and object that passes through the locker holes or crevice between the door and the locker wall.

### SUMMARY OF INVENTION

The present invention relates to a locker lock design that can be made into a vertical built-in latching mechanism or a horizontal built-in latching mechanism. The improved locker lock provides for a high degree of security as well as a high degree of convenience in use. The present locker lock also provides an improved locker combination change mechanism.

### BRIEF DESCRIPTION OF DRAWINGS

FIGS. 1-4 illustrate the present invention lock assembly, wherein the key cylinder is in the locked position.

FIGS. 5-7 illustrate the present invention lock assembly, wherein the key cylinder is in the unlocked position.

FIGS. 8-11 illustrate the present invention lock assembly, wherein the locking slide is disengaged from the guide.

FIGS. 12-13 illustrate the present invention lock assembly, wherein the guide and bolt are moved to allow the locker door to be opened.

FIGS. 14-20 illustrate the present invention vertical lock assembly and operation with the combination and the relative position between the locked position and the unlocked position.

FIGS. 21-28 illustrate the present invention lock assembly and the combination changing mechanism employed therewith.

FIGS. 29-34 illustrate the present invention vertical lock assembly and dial in different subassemblies to show the relative position of each of the parts of the lock assembly.

FIGS. 35-43 illustrate the present invention horizontal lock assembly and dial in different subassemblies to show the relative position of each of the parts of the lock assembly.

FIGS. 44-57 illustrate the present invention horizontal build-in lock assembly in the locked and unlocked position.

FIG. 58 is a schematic exploded view of the components of the horizontal lock assembly.

### DETAILED DESCRIPTION

Operation of the Key-Operated Vertical Built-In Lock Assembly

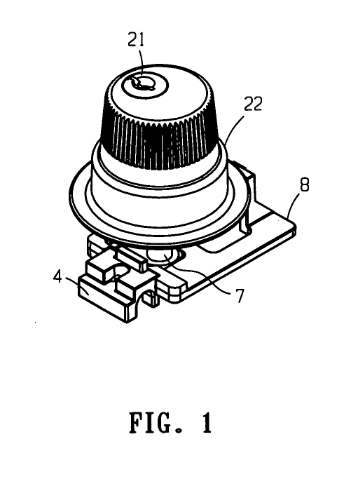

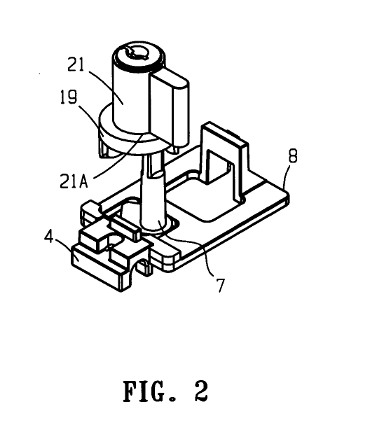

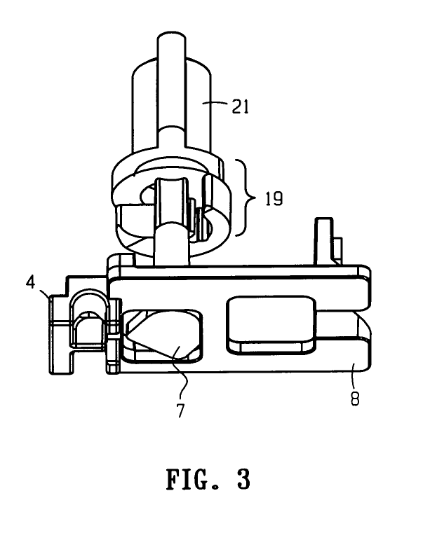

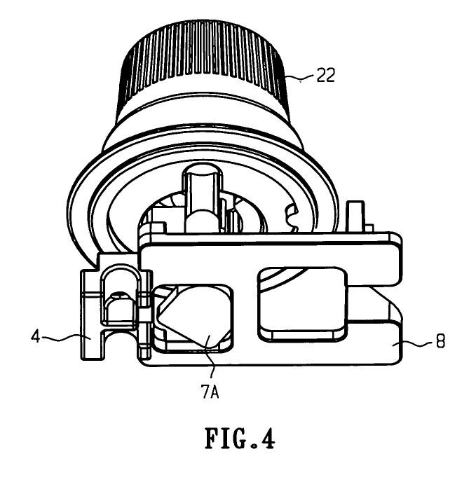

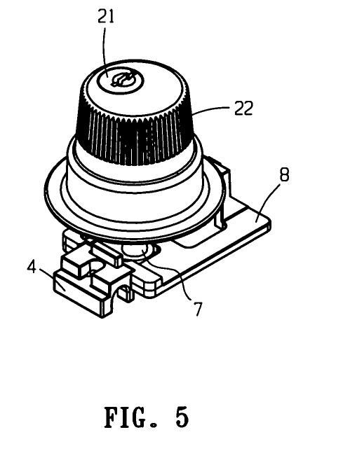

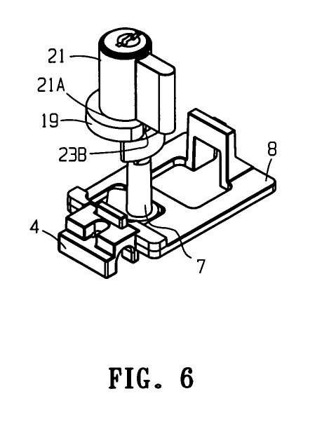

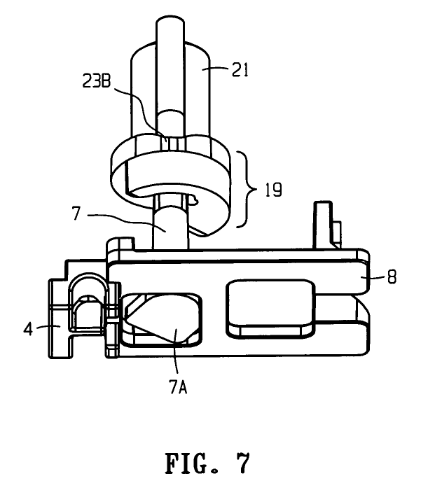

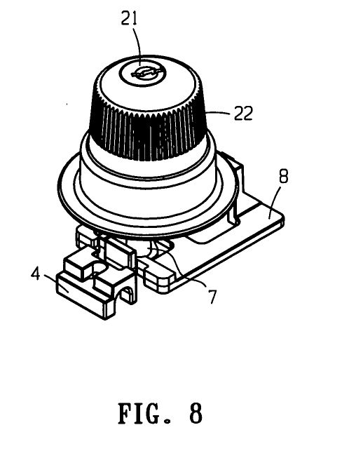

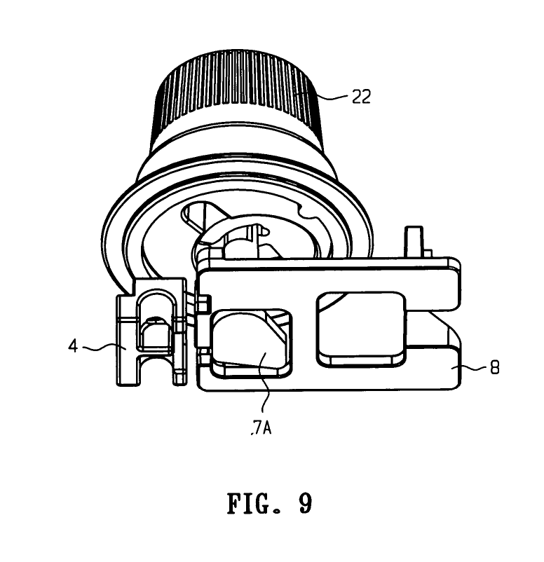

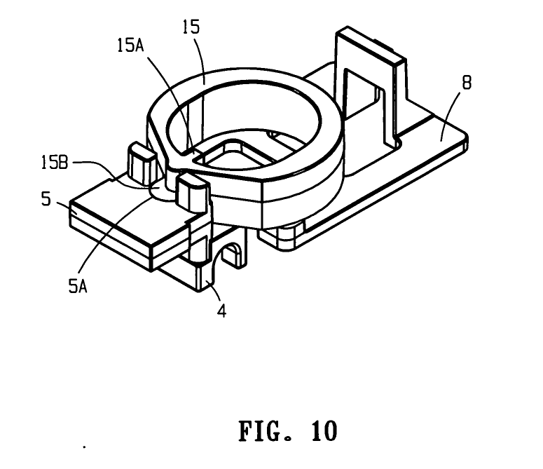

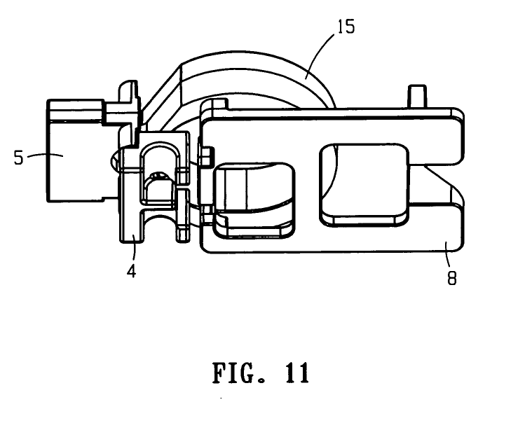

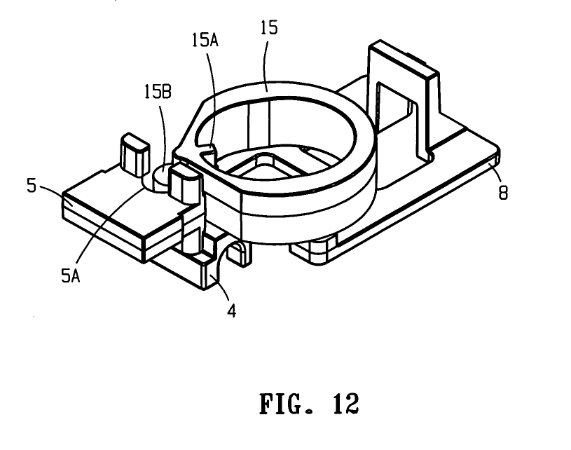

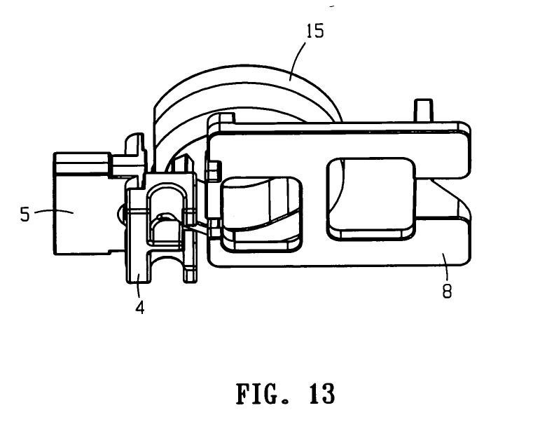

FIG. 1 shows the present invention in a semi-assembled view of the lock and dial in the locked position. For the vertical built-in lock assembly, when the dial assembly 100, which includes number dial 23, tumbler dial 22, key cylinder 21, ball bearing 20, dial cam 19 and tumbler extension 17, is in the locked position, as shown in FIG. 1, the dial assembly 100 can rotate about the axis of the tumbler dial 22 axis without engaging dial cam 19 into plug extension 7. In this state, the lock can only be opened with the proper combination. If, however, the proper key is inserted into the key cylinder 21 and turned clockwise (as shown in the figures), the key will drive dial cam 19 into engagement with plug extension 7, as shown in FIGS. 5-7. Once the plug extension 7 is engaged, and rotated to the designated stop, the continued rotation of the key will rotate the dial assembly 100 with plug extension 7 thereby disengaging locking slide 8 with guide 4. This is shown in FIGS. 8-11. Once the guide 4 is disengaged, the guide 4 can be moved along with the bolt 5 and bolt retainer 15 by the locker handle (not shown) vertically (as shown in the drawings), thereby disengaging the locker door mechanism and allowing the locker door to be opened, as shown in FIGS. 12-13. Once release, and the key is turned back for removal, guide spring 3 push the guide 4, bolt 5 and bolt retainer 15 back into the center of the lock, where locking slide 8 is reengaged into guide 4 by the force applied by slide spring 14, and the lock is then relocked.

Operation of the Dial Operated Vertical Built-In Lock

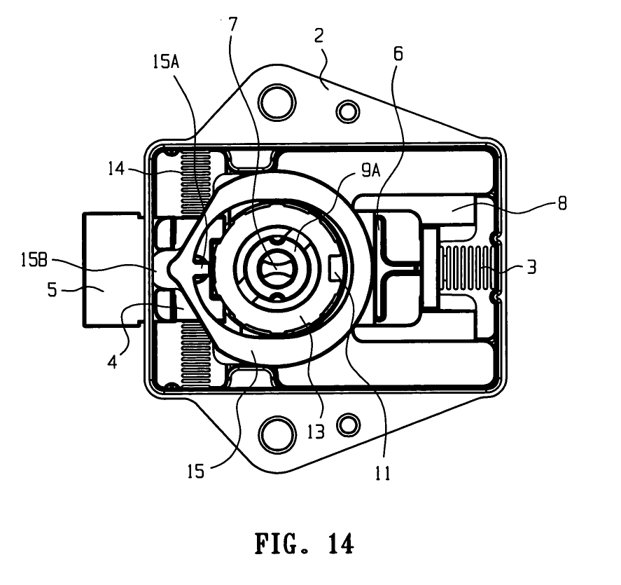

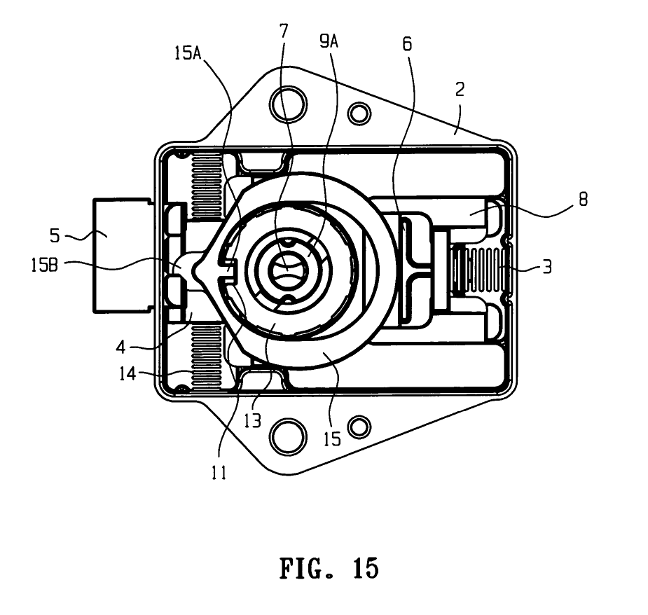

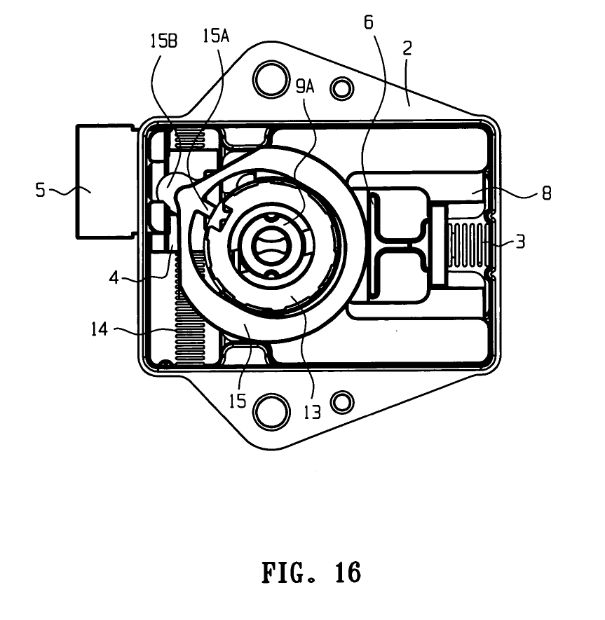

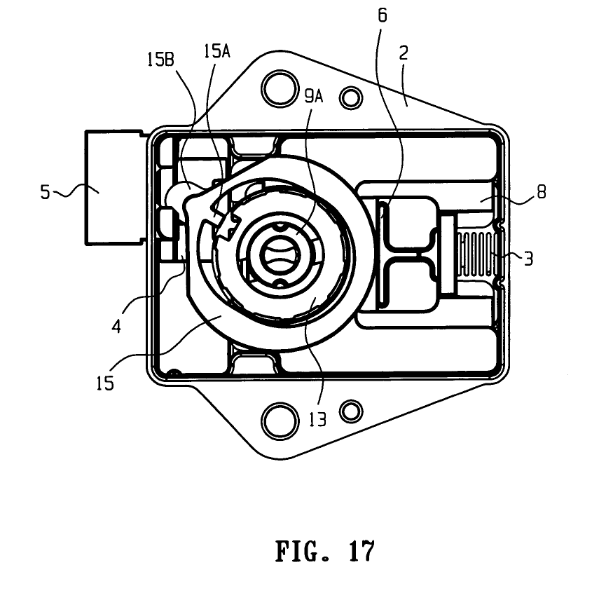

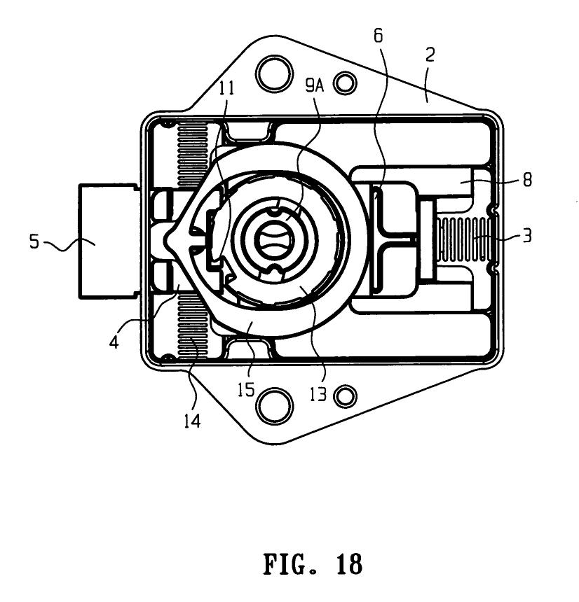

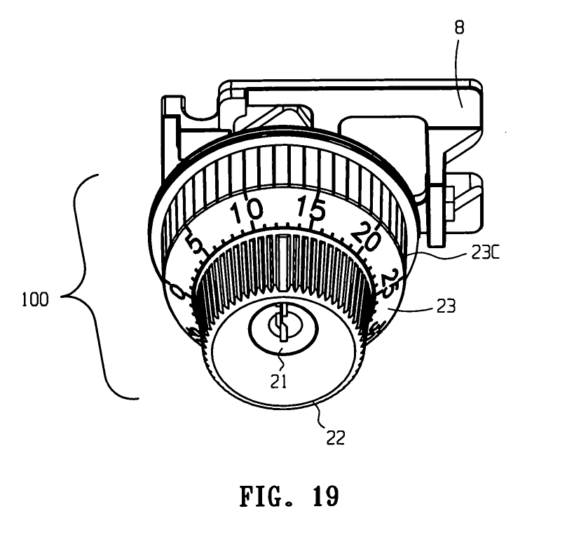

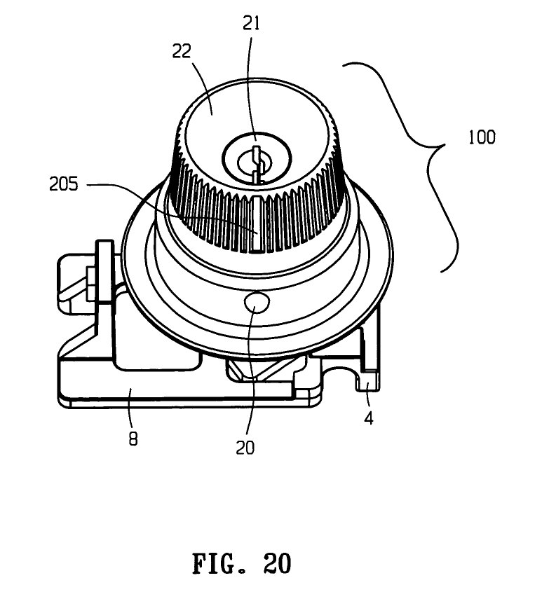

FIG. 14 shows the top view of the vertical lock in the locked position with top tumbler 10, middle tumbler 12, and bottom tumbler 13 in the upset position. The bolt 5 can be pushed up very slightly until the bolt retainer 15 advances to the tumblers 10, 12, and 13, and stops. This does not allow the bolt retainer 15 to disengage the locking slide 8 with guide 4, and allow the bolt to move to its fully opened position. As shown in FIG. 15, when the dial is turned, tumblers 10, 12, and 13 are manipulated to the proper position, bolt 5 can push the bolt retainer 15 into tumblers 10, 12, and 13. This will also disengage locking slide 8 from guide 4, and thus allows bolt 5 to move to the fully opened position. The guide 4 and bolt retainer 15 follow as well as tumblers 10, 12, and 13. This is shown in FIGS. 16-18. When the lock is released, the bolt 5, bolt retainer 15, and guide 4 will be pushed back into their original position by guide spring 3. Simultaneously, the lock slide spring 14 in conjunction with the pressure slide 6 will push the bolt retainer 15 out of tumblers 10, 12, and 13. The momentum of tumblers 10, 12, and 13 will carry them past the position where the lock can be opened again, as shown in FIGS. 19 and 20. Due to the symmetry of the lock, it can be pushed in the opposite direction for use on the opposite hand locker door.

Regardless of whether the present invention vertical built-in lock is operated by key or by manipulation of the combination dial, the present invention vertical built-in lock provides for easier use and improved security over the prior art. Specifically, the design of the present invention built-in vertical lock provides for increased movement of the locking bolt, namely from 3/8 inch to 15/32 inch. This increased movement of approximately 3/32 inch provides for greater engagement and travel of the locking rods, which further minimizes the ability to corrupt the locking mechanism which would allow unauthorized entry into the locker. In addition, the vertical built-in lock of the present invention is symmetrical, thereby allowing one lock to be used on either right-handed or left-handed lockers.

Operation of the Key-Operated Horizontal Built-in Lock

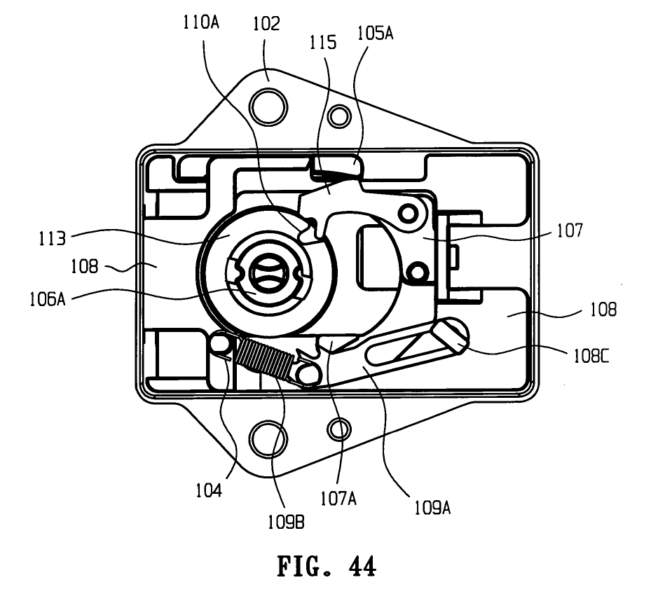

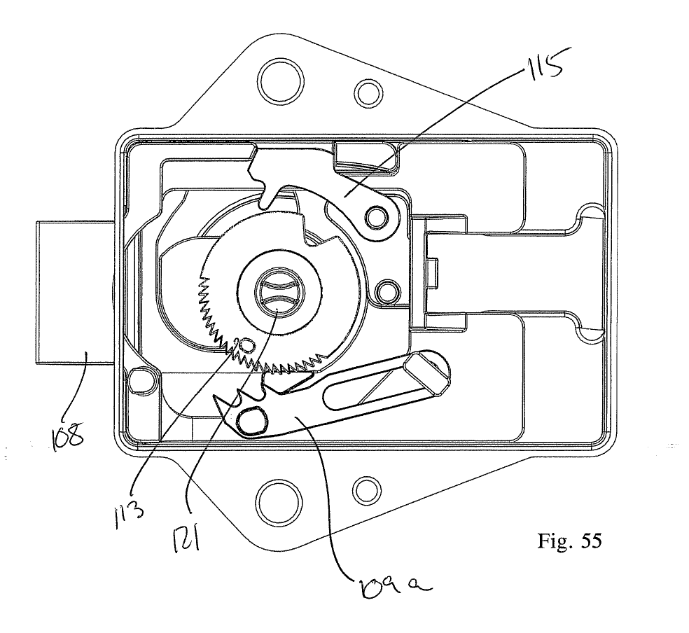

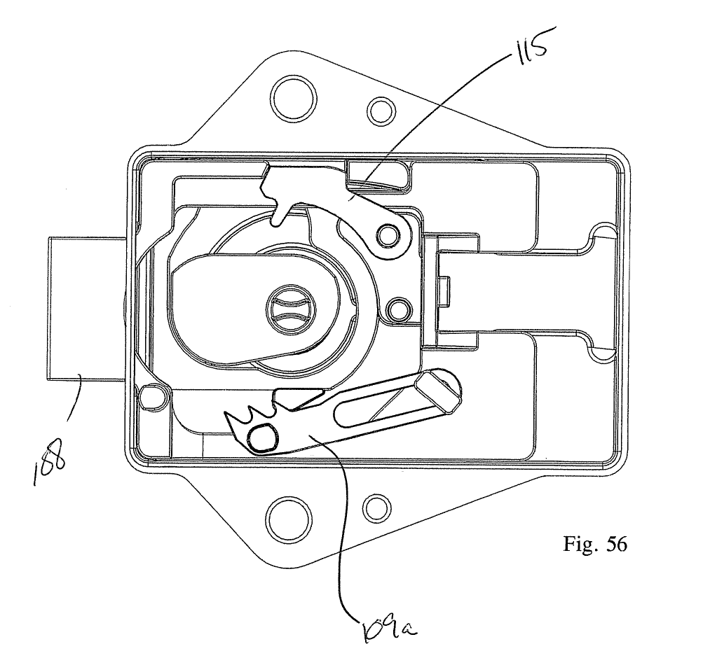

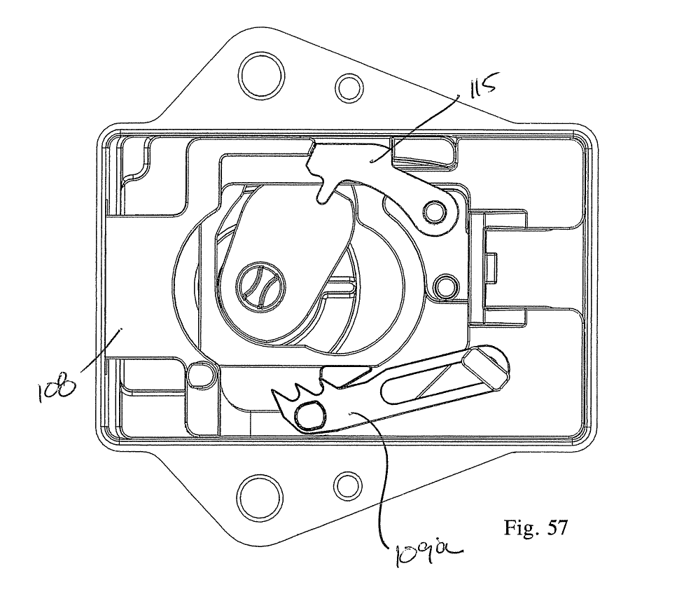

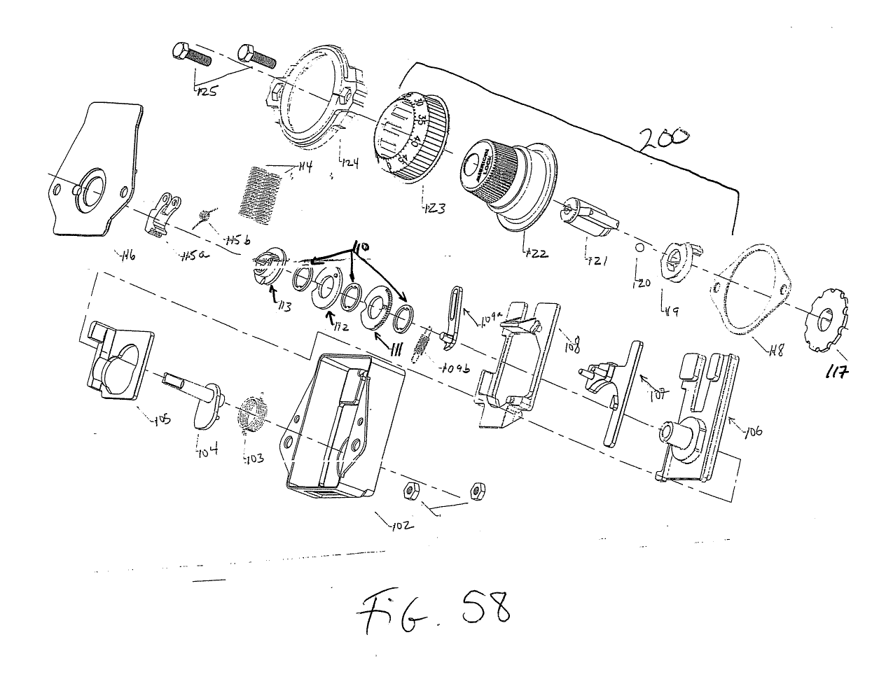

Opening the horizontal lock is similar to opening the vertical lock, as far as the dial assembly is concerned. The dial cam 119 engages the plug extension cam 104 on the horizontal lock in a similar manner as it did on the plug extension 7 with the vertical lock. FIGS. 44-57 illustrate the horizontal built-in locking assembly. The locked positioned and alignment of the lock and dial are shown in FIG. 56. Once the dial cam 119 is engaged, and rotated to the designated stop, the continued rotation of the key will rotate the dial assembly 200, including number dial 123, tumbler dial 122, lock cylinder 121, ball bearing 120, dial cam 119, and tumbler extension 117, with plug extension cam 104 thereby moving cam plate 105. Since paw plate 107 and bolt 108 are stopped against cam plate 105, the entire assembly will be moved to the open position, and the locker door can now be opened, as shown in FIG. 57. Once released, and the key is turned back for removal, plug extension cam spring 103 rotates plug extension cam 104 back to its original locked position, while springs 114, or bolt and paw plate springs, push cam plate 105, paw plate 107 and bolt 108 back to the locked position of the lock.

Operation of the Dial-Operated Horizontal Built-In Lock

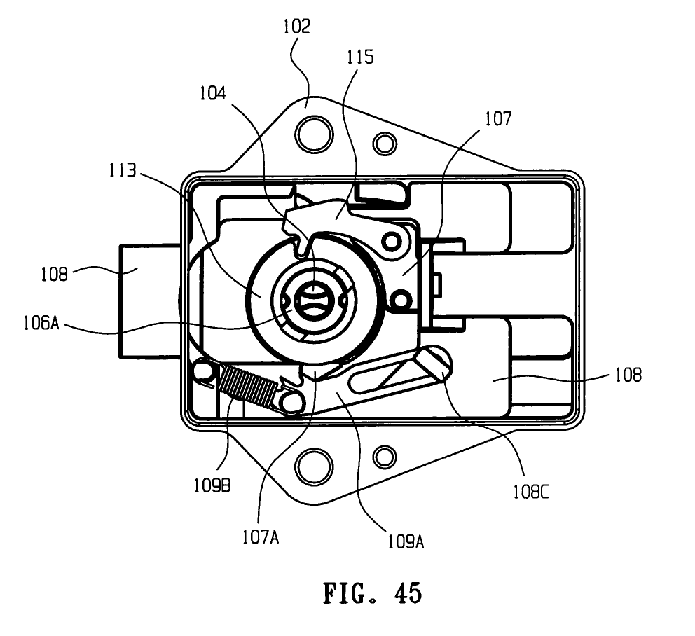

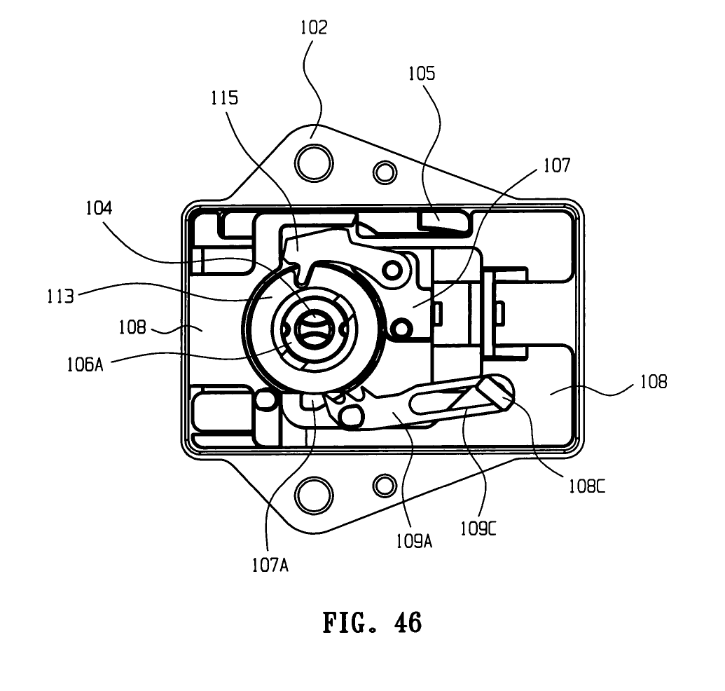

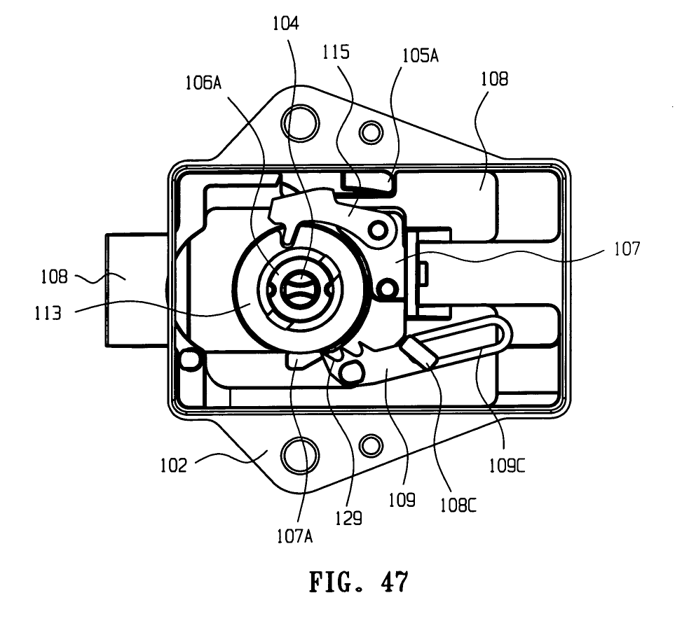

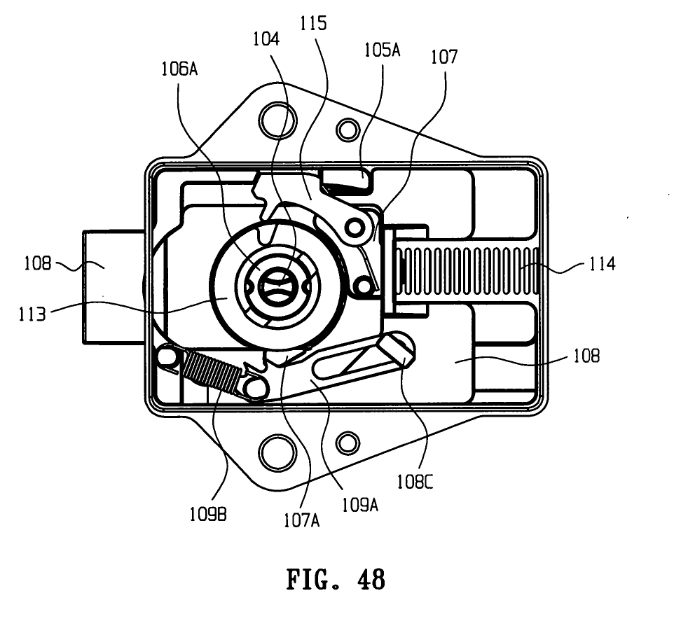

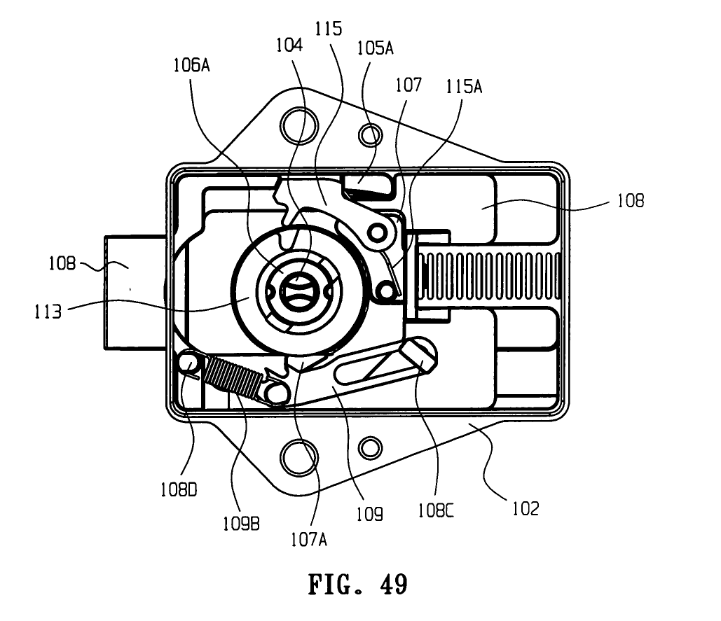

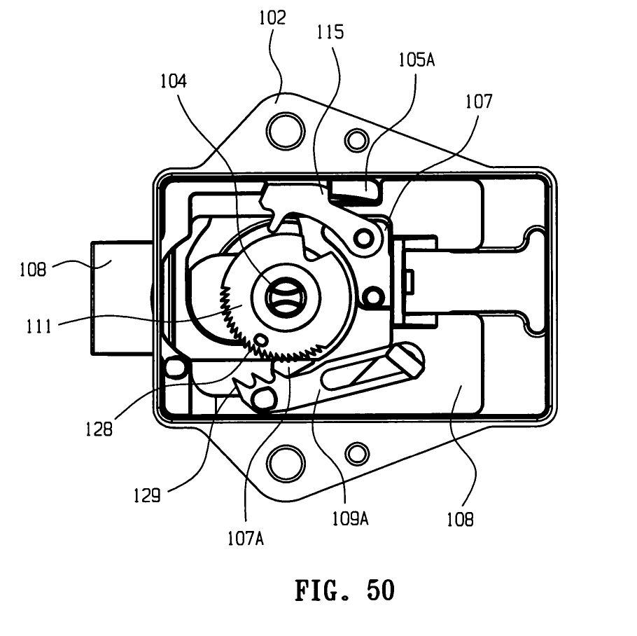

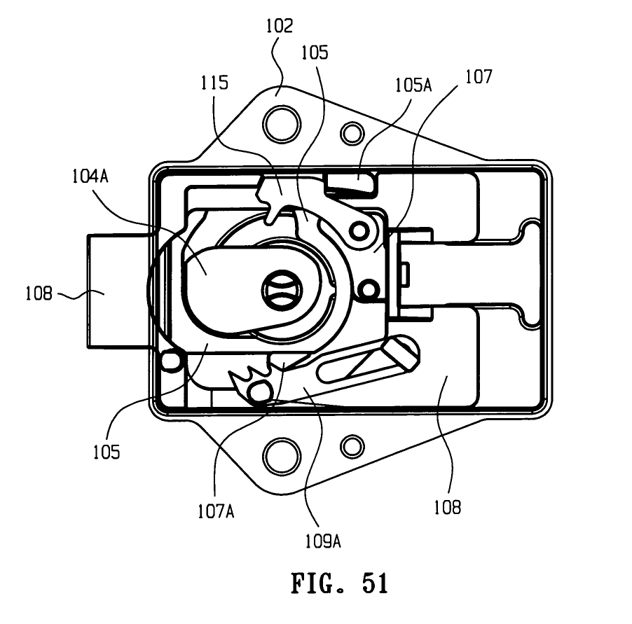

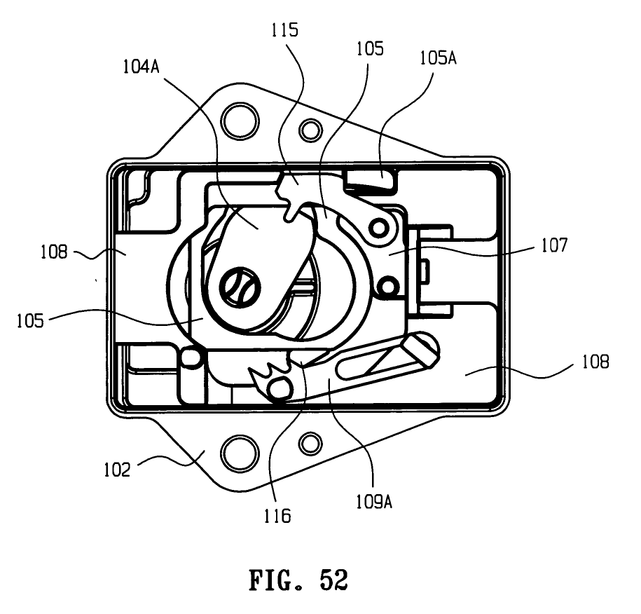

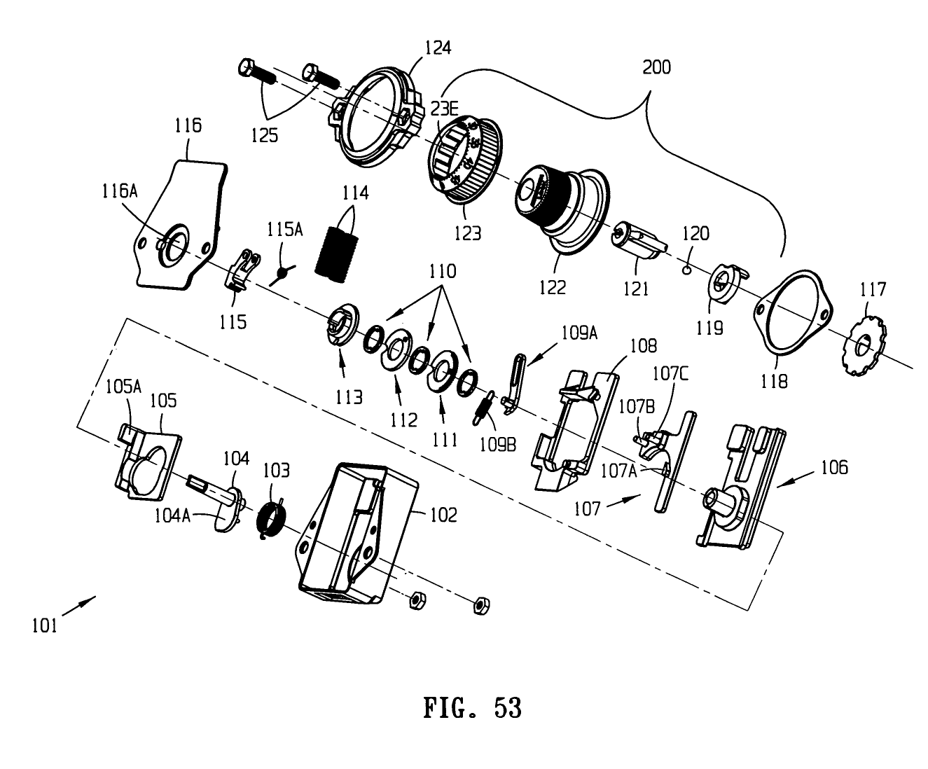

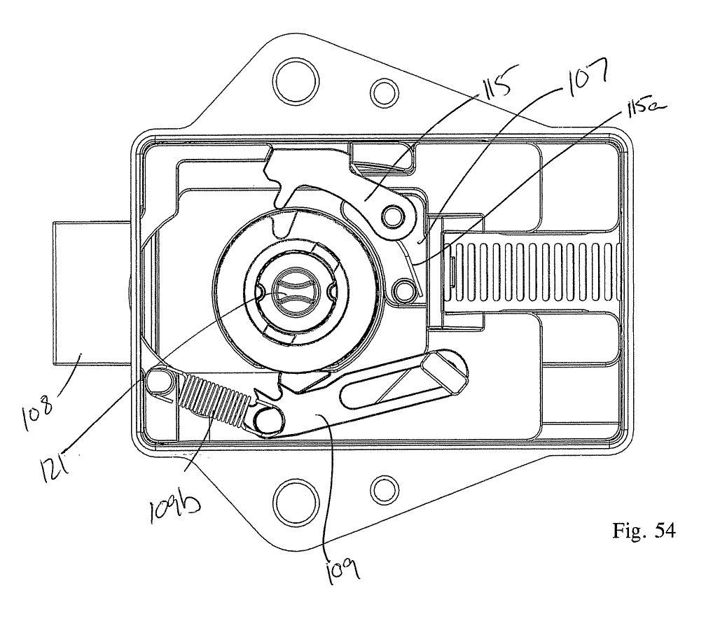

FIGS. 44 and 45 show the top view of the horizontal lock in the locked position with top tumbler 111, middle tumbler 112, and bottom tumbler 113 in the upset position. The bolt 108 can not be pushed in due to the plug extension cam 104, cam plate 105 and paw 115 all being in the locked position. As shown in FIG. 46, when the dial is turned and tumblers 111, 112, and 113 are manipulated to the proper position, paw 115 can push paw spring 115a into tumblers 111, 112, and 113. Further turning of the dial will push paw 115, and paw plate 107 against bolt 108 and retract bolt 108 to the open position, as shown in FIG. 47. When the locker is opened, the dial can be released, and paw spring 115a, paw plate 107 and bolt 108 will return to the previous position by bolt and paw plate springs 114, as shown in FIG. 48. In this position, the lock can be opened and closed as many times as needed, but only by turning the dial back and forth. If, however, the locker door is closed and the dial is not turned, paw 115 and paw plate 107 will stay in the position shown in FIG. 48 by the lower spring 14 while the bolt 108 along with upsetter 109a will move into the open position by the edge of the locker, as shown in FIGS. 49 and 50. This will allow upsetter 109a to disengage paw plate 107 and engage into tumbler 111. When the locker is finally closed, the bolt 108 will move to the locked position by the upper spring 114 while upsetter 109a will stay engaged into tumbler 111, as shown in FIGS. 51 and 52, until there is adequate room between cam plate 105 and bolt 108 for upsetter spring 109 to pull upsetter 109a and rotate 111 ultimately pushing paw 115 back into the locked position, as shown in FIGS. 53 and 54. Due to all parts being positively engaged and disengaged by springs, the lock can be used on the opposite hand locker door.

Regardless of whether the present horizontal built-in lock is operated by key or by manipulation of the combination dial, the present horizontal built-in lock provides for easier use and improved security over the prior art. Specifically, the design of the present built-in horizontal lock provides for increased travel or movement of the locking bolt, namely from 7/32 inch to 13/32 inch. This increased movement of approximately 3/16 inch provides for greater engagement and travel of the locking rods, which further minimizes the ability to corrupt the locking mechanism which would allow unauthorized entry into the locker. In addition, the horizontal built-in lock of the present invention is symmetrical, thereby allowing one lock to be used on either right-handed or left-handed lockers. Furthermore, the present invention horizontal built-in lock includes the security of the present dead bolt mechanisms and the ease of use of the present spring bolt mechanisms. The present invention is designed to be a dead bolt in the locked position. When the proper combination is dialed, further rotation of the dial will push the locking bolt into the unlocked position, and allow the locker door to open. When the locker is open, the dial can be released, and the bolt will extend. The bolt is however, not in the dead bolt position, but rather in the spring bolt position. The locker can then just be closed. The bolt then acts like a spring bolt in that the locking bolt will retract into the lock and once the locker door is in the closed position, the locking bolt will extend back to the locked position. The lock will then be in the dead bolt mode. This means that it is designed for more security in that the bolt can not be manipulated by objects stuck into the locker.

Built-In Dial Combination Changes With Key

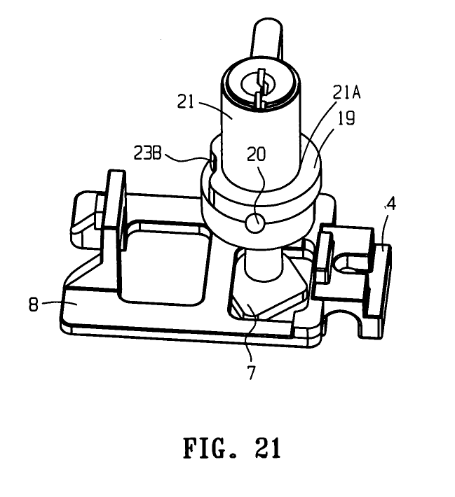

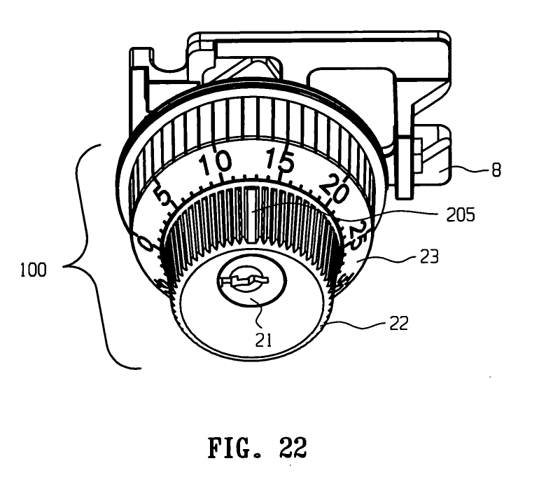

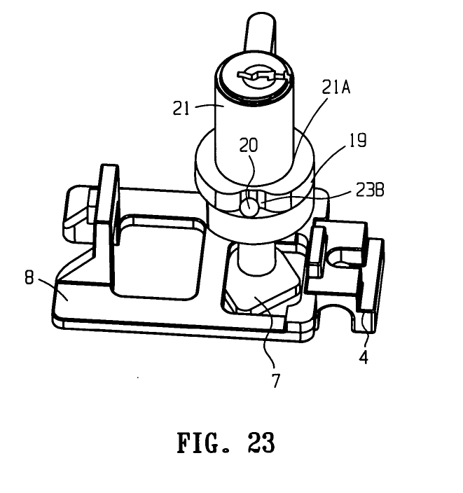

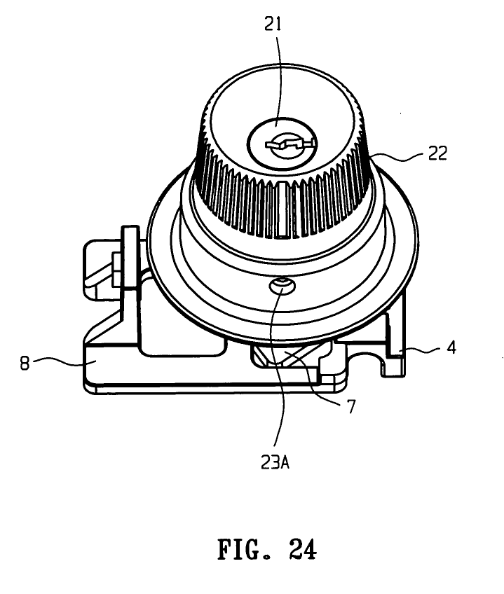

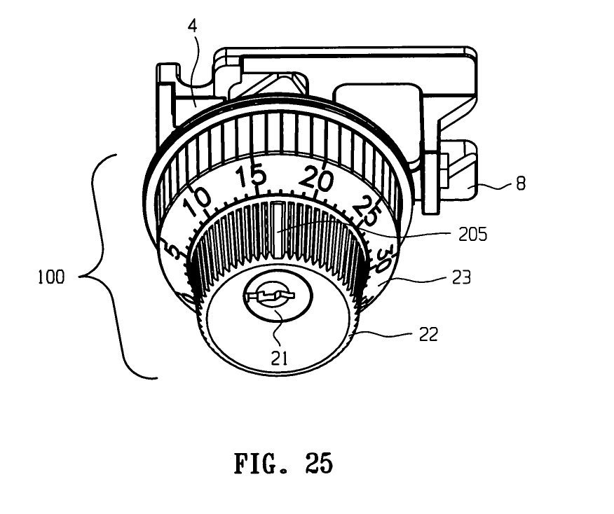

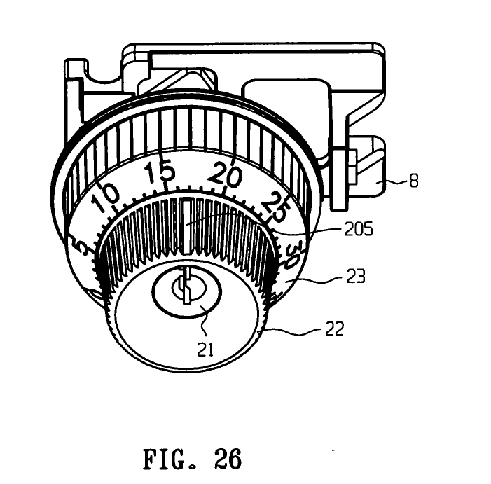

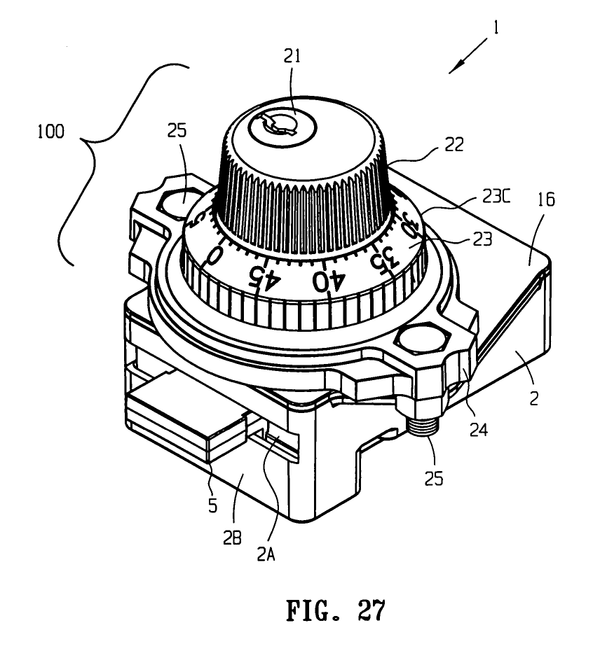

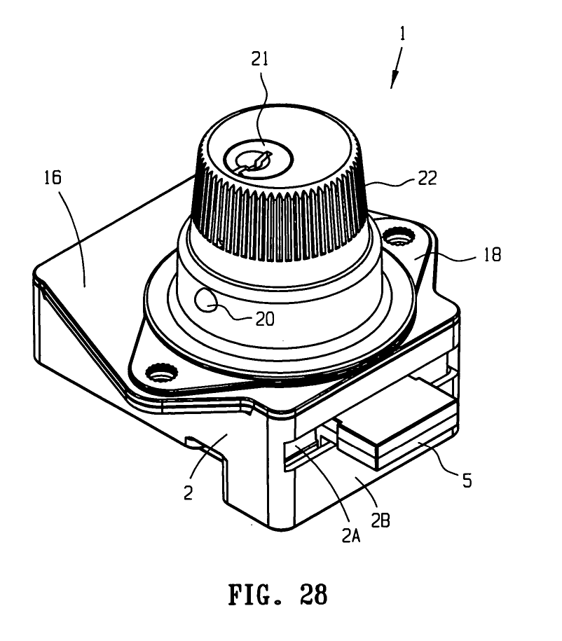

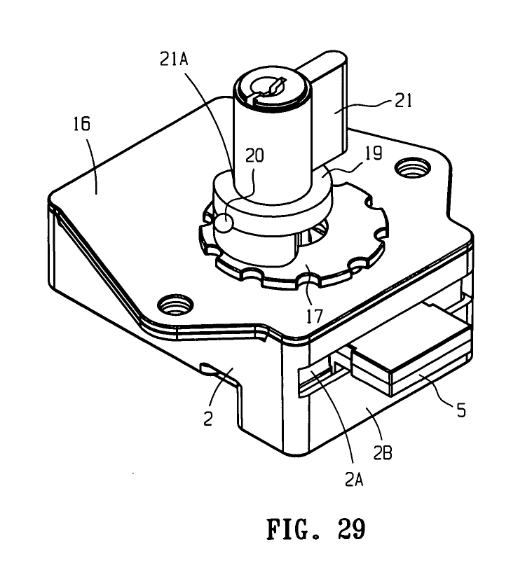

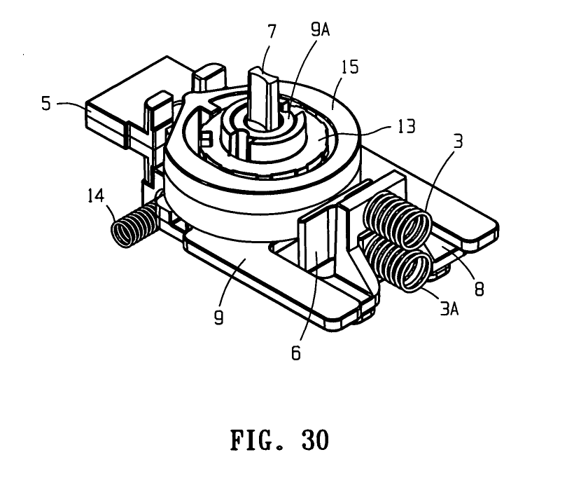

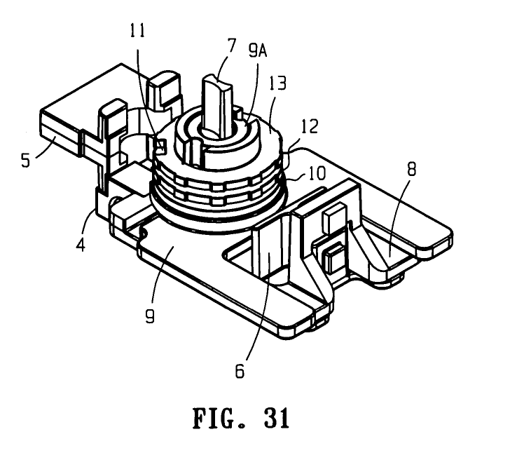

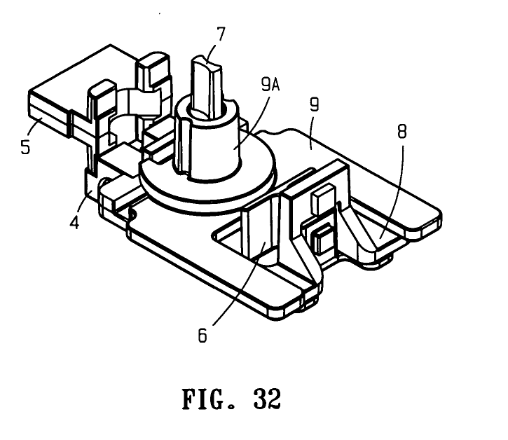

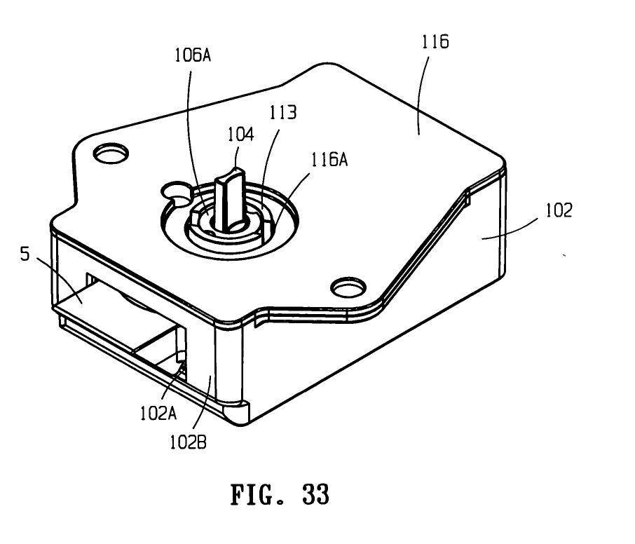

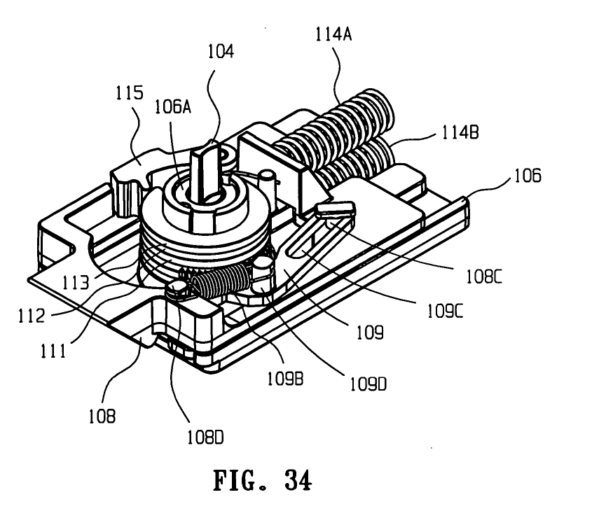

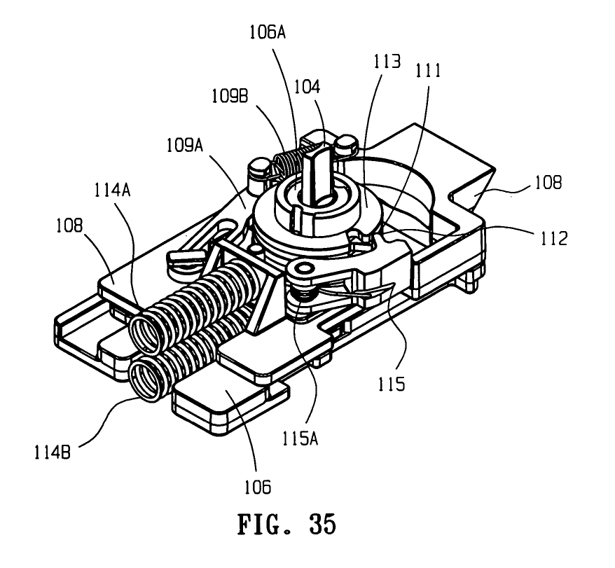

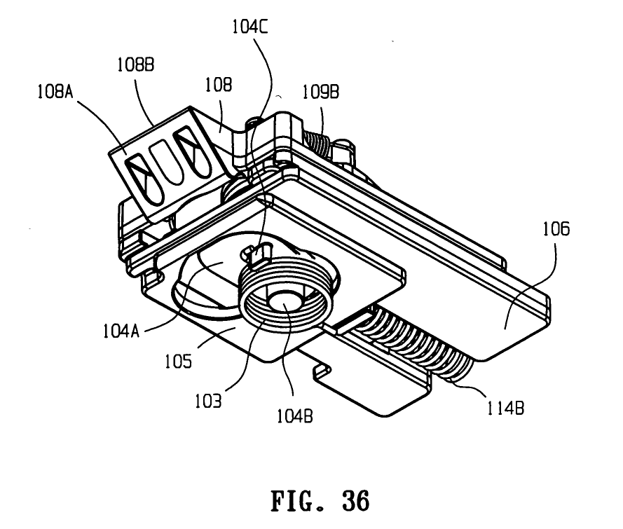

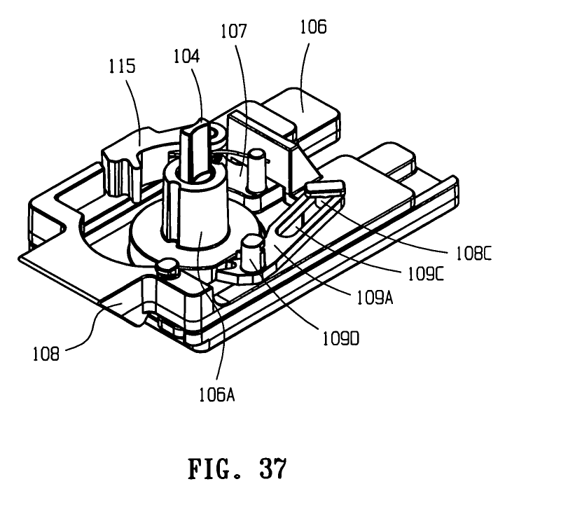

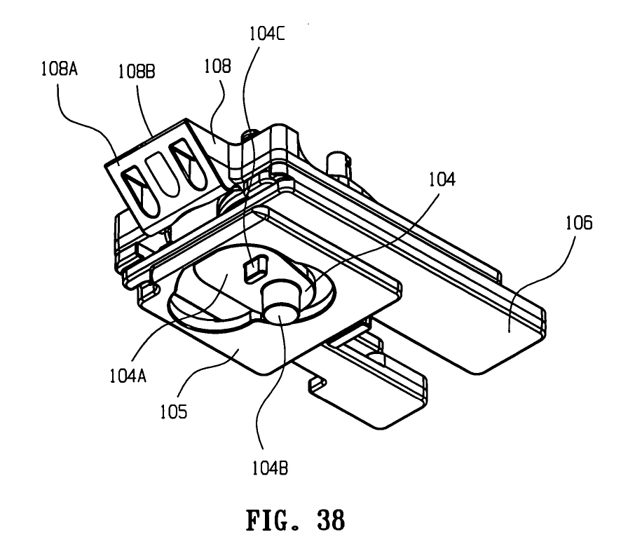

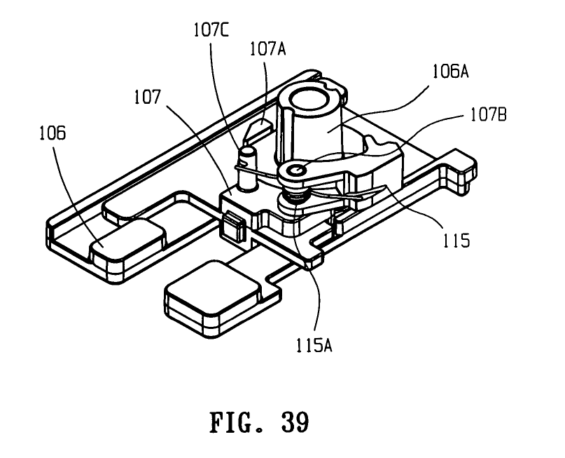

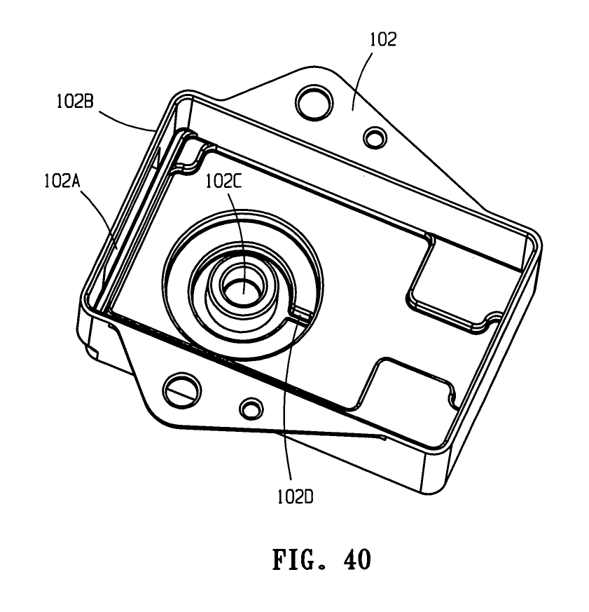

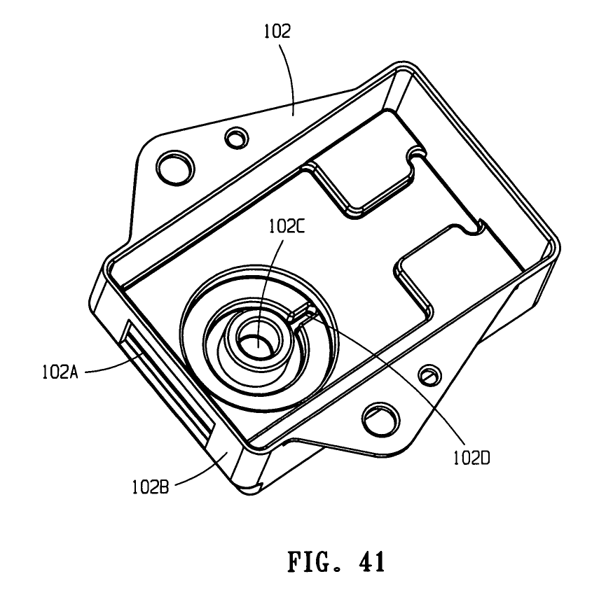

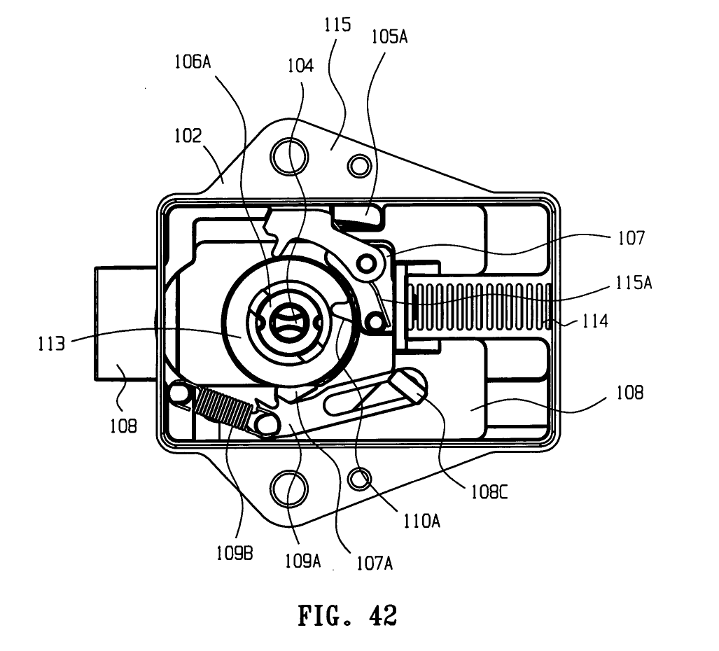

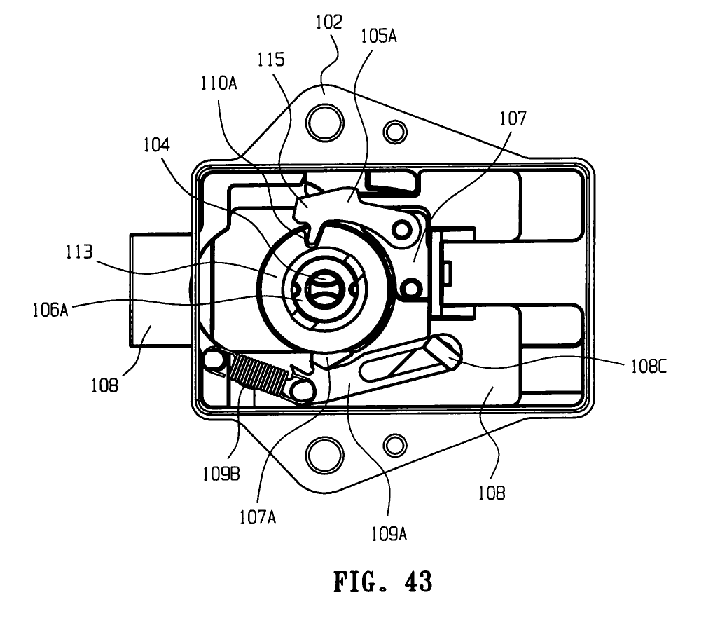

FIGS. 21-23 show a semi-assembled view of the lock and dial in the locked position. Ball bearing 20 protrudes from the tumbler dial 22 and engages the number dial 23 through ball bearing holder 23a. The engagement of ball bearing 20 in holder 23a forces number dial 23 to spin in conjunction with tumbler dial 22. As shown in FIGS. 24-26, when the proper key is inserted into the cylinder plug 21 and turned counter-clockwise (as shown in the Figures), dial cam 19 will be driven to allow ball bearing 20 to drop into pocket 23b in dial cam 19, thereby disengaging number dial 23 from tumbler dial 22. The number dial 23 can then be rotated to another position relative to the entire dial assembly 100. The outside of the number dial 23c includes an indicator 205 to provide the combination changer with the proper combination code. One skilled in the art will appreciate that the indictor can be any type of mark, including a dot or series of lines, or grooves, or flat spaces, such as to indicate position. In addition the indictor may also be located on the tumbler dial or another piece the is visible and can provide indication of relative position of the number dial. The lock cylinder 21 can then be rotated back to center, and the lock will have a different combination. FIGS. 21 and 28 show the relative change in the number dial such as to provide a new combination.

The lock assembly of the present invention offsets the entire lock cylinder 21 to allow a larger cylinder to be placed in the dial with the same relative size as the old dial. This offset of the achieved through the design of the dial cam 19 on the end of the lock cylinder 21. The larger cylinder enables the use of an industry standard cylinder, the use of more pins, and the use of more intricate security pins. This will provide greater security, more key cut permutations, and true master key system availability options. In addition, the use of the larger cylinder allows for a larger number of different combination changes. Whereas traditional locker locks have about 5 different changes, the locker lock of the present invention can provide for 12 or more different combinations.

The lock assembly of the present invention also provides for ease of use in the changing of the combination used on the dial. Current assemblies require the locker to be opened, the key to be inserted and rotated and held in position while a button on the back of the lock, inside the locker door, is held. When the button is pressed, the internal driver pin is dislocated and the dial most be continuously turned until the driver pin engages into another position. The key must be turned backed to the locked position and then be removed form the lock cylinder. One the combination has been changed, it must be manually dialed and checked to positively identify the proper position of the internal changing mechanism, ensuring the correct combination. Use of the present invention and the indicator 205 on the outside of the dial signifying the code number, indicating the proper number for the combination code, provides for a much more efficient method of changing the locker combination. The combination code will be known only by the combination changer, so it can not be determined by anyone else. The combination changer can use a system for storing such codes so that retrieval is simplified. As indicated above, to change the lock combination, the key is inserted and turned counter-clockwise, the number dial 22 is turned relative to the tumbler dial 23. The key is then turned back to the locked position and the key is removed. The number signified by the indicator 205 is the code for the lock combination. The locker does not need to be opened and the combination does not need to be checked.

The present invention also includes a retaining plate 24 which provides a new and improved design. It also has two places for screws to drop in, so a further covering of the screws with a sheet metal plate is unnecessary. A plastic piece 18 that has holding points inside of its two small holes, allows for easy assembly.

The foregoing descriptions of preferred embodiments of the invention have been presented for purposes of illustration and description. They are not intended to be exhaustive or to limit the invention to the precise form disclosed. Obvious modifications or variations are possible in light of the above teachings. The embodiments provide an illustration of the principles of the invention and their practical application, and enable one of ordinary skill in the art to utilize the invention in various embodiments with various modifications suited to the particular use contemplated, and within the scope of the invention as set forth in the following claims.

1. A locker lock comprising:
a tumbler dial which is engaged by a number dial;
a lock cylinder and a cam;
one or more lock tumblers; and
a means for engaging and disengaging the lock, wherein said means includes a locking bolt;
wherein said lock cylinder is off set from the cam to require greater movement of said locking bolt to engage and disengage the lock.

2. The locker lock of claim 1, further comprising an indication means provided on the tumbler dial; wherein said indication means provides indication of the combination used to lock and unlock the locker lock.

3. A method of changing the combination of a lock on a locker, said method comprising the step of:
inserting a key into a lock cylinder of the lock;
rotating said key;
rotating a number dial relative to a tumbler dial;
turning the key back to the locked position; and
wherein the locker is not opened during the process of changing the combination.

4. The method of claim 3, further comprising aligning the number dial with an indication means; wherein said indication means provides indication of the combination used to lock and unlock the lock.
